(19) United States
(12) Patent Application Publication
(10) Pub. No.: US 2010/0217749 A1
(43) Pub. Date: Aug. 26, 2010

(54) Method and system for optimizing the storage of different digital data on the basis of data history

(76) Inventor: Tobias Ekbom, Stockholm (SE)

Correspondence Address: NIXON & VANDERHYE, PC, 901 NORTH GLEBE ROAD, 11TH FLOOR, ARLINGTON, VA, 22203, US

(21) Appl. No.: 12/308,362

(22) PCT Filed: Jun. 15, 2007
(86) PCT No.: PCT/SE2007/050427

§ 371 Date: May 11, 2010

(30) Foreign Application Priority Data
Jun. 16, 2006 (SE) 0601336-1

(51) Int. Cl. G06F 17/30; G06F 17/00

(52) U.S. Cl. 707/638; 707/752; 707/E17.005

(57) ABSTRACT

The present invention relates to optimized storage of data in digital memories (11), such as in magnetic disks (hard disks). This is possible since different versions of data often have the same or similar content, despite their form or size having been changed. The occurrences of data repetitions that have a common history at some point can be sorted out, permitting the storage capacity of a digital memory to be used more effectively.

### TECHNICAL FIELD

The present invention relates to a method and to a system of optimizing the storage of data in digital memories on the basis of data history.

### THE EARLIER STANDPOINT OF TECHNIQUES

Developments within algorithms, hardware for data compression, databases and within specialized hardware for optimal storage of digital information have occurred rapidly over latter decades.

A shared characteristic of compression algorithms and normalized databases (databases in which identical occurrences of data is replaced with reference addresses or other identification data) is that they are only able to sort out repeated data which is identical with respect to form and magnitude. The repetition of the same data in different forms cannot therefore be sorted out completely if such data differs only at the slightest, despite the data being the same or similar in its practical application. This drawback is also shared by existing storage systems and file systems constructed as normalized databases.

Examples of dissimilar occurrences of data that have a common history are copies of data files that have been compressed, encrypted or processed in some other way such as to change the files completely or partially. In many cases the practical application of the file is not changed, despite the file having been altered. If the file cannot be used directly subsequent to being changed, it is often possible to recreate the earlier version of the file and then use the recreated version. The storage of such repeated occurrences of data can result in significant losses of storage capacity in certain storage systems.

### SUMMARY OF THE INVENTION

An object of the present invention is to optimize the use of the storage capacity of digital memories. This is achieved by sorting out repeated occurrences of data that has a common history, irrespective of whether or not this data is totally dissimilar per se.

Such sorting is possible when the practical application of data is the same despite changes in form or magnitude, and when earlier versions of data can be recreated from the changed data.

Data sequences can be distinguished with the aid of identification information, such as name, time of day, an earlier storage address, a checksum (digital “fingerprint” for data created by different arithmetical algorithms) or by a combination of such information. When the systems that change stored data also update a version history in response to changes, repeated occurrences can be identified and avoided irrespective of the dissimilarity between the data occurrences.

It is normally not relevant to save two versions of, for instance, a data file as a single entity when the contents of the file has been changed so radically as to consider that a new first generation has been created. But many data changes are such that change the form of the data rather than its content or the practical application of said content. For instance, a so-called WAVE-data file containing a digital description of sound wave forms can be compressed in different ways, encrypted in different ways and have the sound volume adjusted without its content normally being experienced as having been changed.

Moreover, smaller data sequences may be identical at some point according to their history, despite the fact that the larger computer units from which the sequences originate have not, in their entirety, been identical at any point.

Thus, smaller sequences of data can, in many instances, be stored as a single sequence, despite the sequences originating from larger units of data that lack a common history in their entirety, and despite that said sequences can be read back as parts of said larger units.

This enables large quantities of storage space to be saved with the aid of a storage system that is able to distinguish between different versions of the same data based on its history.

The system efficiency may often be particularly remarkable when the system is used as a storage unit in one or more communication networks containing, for instance, measuring equipment, telephony equipment, computer servers or personal computers, where several external units often share a large amount of data that has a common history.

More specifically the present invention enables digital data to be stored more effectively, in accordance with the following:
1. If the sequences of digital data being sorted are smaller than the units required to enable stored data to be re-read in an expedient manner, there is stored in a digital memory information concerning the data sequences that build up a convenient full unit of data and the order in which the data sequences shall be joined together.
2. Identification information relating to at least one earlier version of each sequence of data stored is stored in a digital memory. The data sequences and the identification may either have fixed or variable lengths. Identification information relating to the version of data actually stored in the system may also be used in order, for instance, to determine whether or not errors have occurred when writing or reading into or from the digital memory. This is however not significant to sorting out repeated occurrences of data based on data history in accordance with the invention.
3. When a new sequence of data shall be stored, identification information in the version history for the data is compared with the identification information in the version history of data sequences that have earlier been stored. This comparison includes comparisons between earlier versions of the new sequence and several earlier versions of stored sequences through the medium of saved identification information. If the history of the new sequence coincides at some point with the history of an earlier stored sequence, the new data sequence is not saved. Instead, there is saved a reference to the earlier stored data sequence.
4. Nevertheless, the history of this new data sequence is normally stored in point 3, despite the sequence not being stored per se. This is done in order to render the system more effective and to simplify the re-reading of data from the system.
5. If historical identification information for the new data sequence fails to coincide at any point with historical information relating to earlier stored data sequences, the new data sequence is stored in the digital memory. The history of the new data sequence is also stored.
6. When reading smaller data sequences from the system, the selection is based on historical identification information. The system then endeavors to identify a stored sequence that constitutes a relevant later version of the data sought. This sequence is then read from the digital memory.
7. When reading larger data units that consist of several smaller sequences, the digital memory that stores the history of the larger units is read first. This history shows those sequences which together can recreate the unit and the order in which the sequences must be combined. Relevant smaller data sequences are then read and combined into the larger unit desired.
8. Restoration of earlier data versions from later data versions can be achieved in many instances when so desired (such as in the case of many forms of data compression and encryptions). For example, relevant algorithms or hardware may recreate earlier data versions from later versions in a stepwise fashion, whereafter identification information relating to the desired earlier version is compared with the identification information of the currently recreated version. If the identification information coincides, the earlier data version can be considered to have been recreated.

The inventive method also enables other benefits. For example a storage system is able to subsequently compress data that has already been stored, or to decompress the data that has already been stored and then compress the data again with a method that is more effective than was previously the case, without needing to change earlier identification information relating to this data and without rendering re-reading of the information complicated.

When using the invention as a medium, for instance, for data backup copying of one or more external magnetic discs (hard discs) the system may store address information, such as sector addresses for earlier versions of data sequences, also enabling simple reading or recovery in accordance with the invention. The address information for earlier data versions is then preferably saved in a separate digital memory, in which the identification information relating to smaller data sequences is coupled together with the address information.

### BRIEF DESCRIPTION OF THE DRAWINGS

A method according to the present invention will now be described in detail with reference to the accompanying drawings, in which

FIG. 1 is a schematic and simplified sketch of how version identification information for data is generated;

FIG. 2 is a schematic and simplified illustration of how repeated occurrences of data is sorted out on the basis of history information; and

FIG. 3 illustrates the method implemented in a control card for a magnetic digital disk unit.

### DESCRIPTION OF PREFERRED EMBODIMENTS

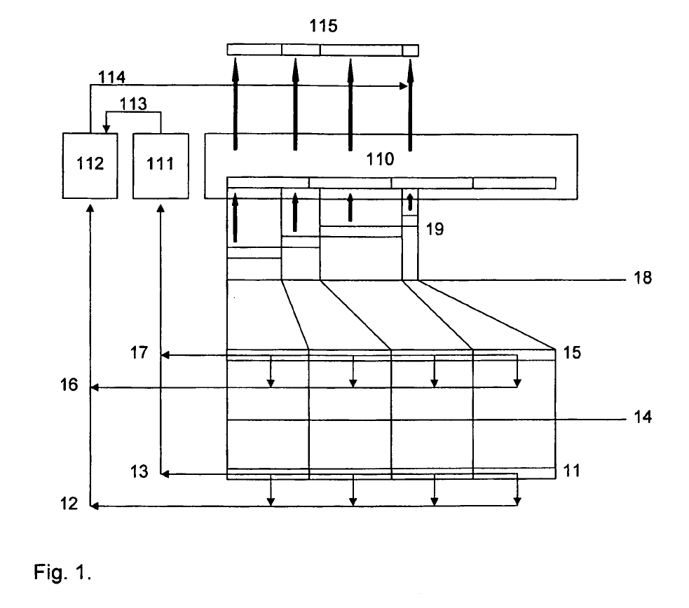

FIG. 1 illustrates how version identification information for data is generated. A larger unit of data consists of several data sequences which are stored in a digital memory (11). For each smaller sequence of data there is created (12) identification information which, together with the information relating to the current version of the sequence, is stored in another digital memory (112). A compiled list (13) of the smaller data sequences which are included in this version of the larger complete data unit is saved in the digital memory (111). At point (14) the whole of the data unit or parts thereof is/are changed, which results in a new disparate data unit (15). The above process is repeated with regard to this new, larger data unit including the creation and storage of identification information (16) and compilation information (17) in respective digital memories (112) and (111).

When a further change (18) is made in the data unit, the length of each data sequence and the data unit as a whole (19) is also changed. So as not to use unnecessary amounts of memory space when the size of data has diminished, the data sequences are packed together to form a shorter continuous data unit when stored on the magnetic disk (110).

When reading stored data, information relating to the intended version of data units can be first sought for in the memory (111). This information can then be used to search (113) for information in the memory (112) relating to relevant smaller sequences of data included in the unit as a whole.

Data sequences are then read to provide a full data unit (115) via the list of relevant sequences (114) obtained. Subsequent to reading these data sequences, external systems determine the correct subsequent treatment of this data in which the data may be decoded, unpacked from a compressed state or used without modification.

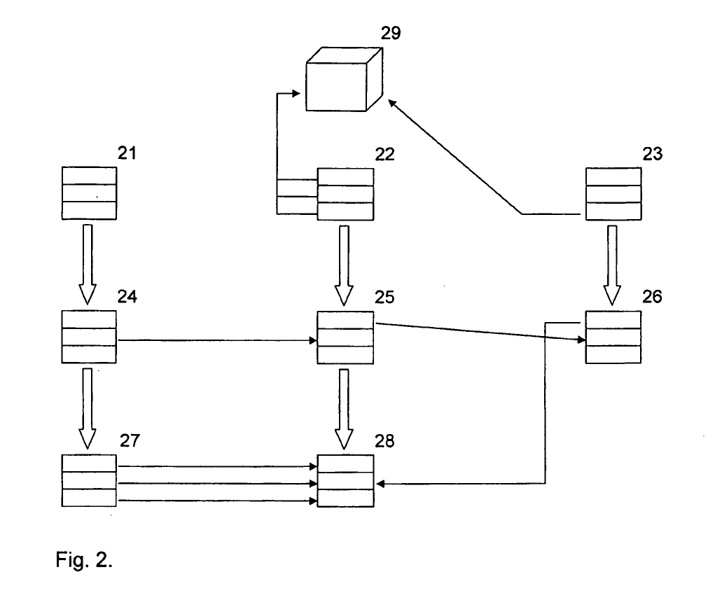

FIG. 2 illustrates how multiple occurrences of data is sorted out on the basis of history information. In this example there are used solely units and sequences of data that have a permanent, predetermined length. The system is given data units (21), (22) and (23) for storing.

These three data units are completely dissimilar from one another and each unit consists of three smaller data sequences. In addition to these data units there are available externally created historical version information which provide identification information for earlier version of these data units and for the various smaller data sequences included in the units. The earlier versions of data unit (21) are designated (24) and (27) respectively, the earlier versions of data unit (22) are designated (25) and (28) respectively, and the single earlier version of data unit (23) is designated (26).

When the system analyses the historical version information it finds that a data sequence was identical between the earlier data units and (24) and (25) and that a sequence of data in the earlier data unit (25) was identical with a sequence in data unit (26).

Moreover, all sequences in the earlier data unit (27) were identical with the sequences in the data unit (28), meaning that these units were also identical in their entirety. Analysis of similarities between different versions of the data units also shows that a data sequence in data unit (26) was identical to a sequence in data unit (28).

On the basis of these comparisons and on the basis of information that this data can be used to recreate earlier versions or is of a type such as to enable sequences of data from different versions to be compiled into a relevant totality, the system sorts out sequences of data that has some common history. Thus, solely data unit (22) and a sequence of data from data unit (23) is saved on the magnetic disk (29).

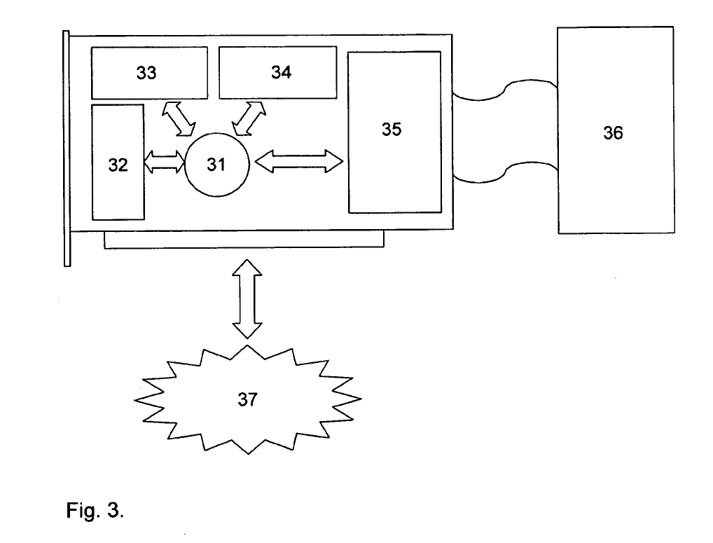

FIG. 3 illustrates the method implemented on a control card for a magnetic digital disk unit (hard disk), meant for use in a computer server or a similar data storage unit.

A processor unit (31) sorts, with the aid of a digital working memory (32) information for larger units of data stored in a digital memory (33) by means of which relevant historical identification information for smaller data sequences stored in memory (34) can be found and read. With the aid of this information obtained from memory (34), the system can then find, read, and compile relevant small sequences of data from the disk unit (36) via its control logic (35). The image also marks the hardware, driver software and similar (37) required for the system to function, although this is beyond the scope of this patent.

1. A method and a system for optimizing the storage of digital information, characterized in that superfluous occurrences of data is sorted out on the basis of such data having a fully or partially common version history; wherein the occurrence of said data can be sorted out even when the data is fully or partially different if similarities are found in an earlier version of said data from which the stored version has been created; wherein redundant occurrences of data are sorted out by handling and maintaining a history list of fixed or variable length, wherein there is stored identification information for earlier versions of the stored data; wherein if one or more points in the history with regard to the occurrence of data coincides with one or more points in the history of one or more other data occurrences, only the first occurrence is stored, and wherein in respect of the occurrence of data classed as redundant there is saved a reference to the corresponding stored data.

2. A method according to claim 1, characterized in that the sorting out of redundant data or the searching for data is handled via determined setups of identification information for data versions that are disparate from the data versions that are stored.

3. A method and a system according to claim 1, characterized in that re-reading of data is based on identification information relating to one or more earlier versions of said data.

4. A method and system according to claim 1, characterized by storing in a digital memory the version history of larger units of data and using this data to find, read and combine small sequences of data into an earlier version of the larger amount of data.

5. A method and system according to claim 1, characterized in that the length of data units or smaller sequences of data that together can recreate a larger data unit in its entirety has a fixed or variable length.

6. A method and system according to claim 1, characterized in that optimization with respect to the speed at which data can be read from the digital memory is also achieved by sorting out the occurrences of superfluous data on the basis of the earlier history of the occurring data.

7. A method and a system according to claim 1, characterized in that the sorting out of similar or identical data occurrences can be based on the earlier history of the occurring data.

8. A method and a system according to claim 1, characterized in that the separation of similar or identical data occurrences can be based on the earlier history of the occurring data.

9. A method and a system according to claim 1, characterized in that subsequent to storage the data can be changed, for instance by subsequent compression, without needing to change earlier existing identification information regarding such data.

10. A method and a system according to claim 1, characterized in that with respect to one or more versions of stored data, the system saves and permits the reading of corresponding addresses of data units or smaller data sequences in external digital storage media.
